(19) United States
(12) Patent Application Publication
(10) Pub. No.: US 2009/0096898 A1
(43) Pub. Date: Apr. 16, 2009

(54) Image-taking apparatus and image signal processing program

(75) Inventor: Masao Sambongi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/315,877

(22) Filed: Dec. 5, 2008

Related U.S. Application Data
(63) Continuation of application No. PCT/JP07/60759, filed on May 22, 2007.

(30) Foreign Application Priority Data
Jun. 7, 2006 (JP) 2006-158105

(51) Int. Cl. H04N 5/202

(52) U.S. Cl. 348/254; 348/E05.074

(57) ABSTRACT

The image-taking apparatus embodied by the invention operates to acquire distance information up to a subject in a pre-taking mode at a distance information acquisition block (1100) provided at a taking control unit (107), thereby setting an area of interest for an image signal at an area-of-interest setting unit (109). The apparatus also figures out a correction coefficient at a correction coefficient calculation unit (111), and uses the correction coefficient at the gray level transformation curve creation block (205) and gray level transformation block (206) provided at the transformation unit (110, 1002) to apply gray level transformation to the image signal.

### ART FIELD

The present invention relates generally to an image-taking apparatus adapted to apply signal processing to image signals and an image signal processing program, and more specifically to an image-taking apparatus for applying gray level transformation to image signals while independently varying gray level transformation characteristics for each pixel or for each area, and an image signal processing programs.

### BACKGROUND ART

With digital still cameras, video cameras, etc. now in use, the gray level width (of about 10 to 12 bits) for signals in an input and processing system is set wider than the gray level width (of usually about 8 bits) of the final output signals to prevent image deterioration by reason of cancellation of significant digits upon digital signal processing. In this case, there is the need of implementing gray revel transformation in such a way as to be in alignment with the gray level width of an output system. So far, gray level transformation has been implemented through the fixed gray level characteristics for standard scenes. JP(A) 2003-143524 discloses a method for processing image data depending on the emission state of stroboscopic light.

However, the method set forth in JP(A) 2003-143524 takes no care of the position information of images, offering a problem in that stroboscopic light intensity differences due to position cannot fully be corrected.

In view of the above problem, a main object of the invention is to provide an image-taking apparatus capable of implementing good gray level transformation and an image signal processing program.

### SUMMARY OF THE INVENTION

According to the invention, the above object is accomplishable by the provision of an image-taking apparatus adapted to apply gray level transformation to image signals obtained by taking a subject, characterized by comprising a distance information acquisition means for acquiring distance information that is information indicative of a distance up to the subject upon image taking, a gray level transformation characteristics setting means for using position information indicative of a position of a pixel to be processed in an image represented by said image signals and said distance information to determine gray level transformation characteristics, and a gray level transformation means for applying gray level transformation to said image signals depending on said gray level transformation characteristics.

The invention is embodied as the first embodiment shown in FIGS. 1 to 7, and the second embodiment shown in FIGS. 7 to 10. The architecture of the invention is shown in FIG. 1, FIGS. 7 and 2, and FIG. 8. The “distance information acquisition means” is equivalent to the distance information acquisition unit 1100 shown in FIGS. 1 and 7; the “gray level transformation characteristics setting means” is equivalent to the gray level transformation curve creation block 205 shown in FIGS. 2 and 8, and the “gray level transformation means” is equivalent to the gray level transformation block 206 shown in FIGS. 2 and 8. The invention is preferably applied to the image-taking apparatus shown in FIG. 1, FIGS. 7 and 2, and FIG. 8. The image-taking apparatus acquires the distance information on the distance up to the subject at the aforesaid distance information acquisition unit 1100 provided at the taking control unit 107 to apply gray level transformation to the aforesaid image signals at the gray level transformation curve creation block 205 and the gray level transformation block 206 provided in the transformation unit 110, 1002.

According to the invention, good gray level transformation may be implemented depending on the position of the pixel to be processed and the distance up to the subject at that position. For instance, good image signals may be obtained in implementing correction of light quantity upon stroboscopic photography.

(A) The image signal processing program of the invention is characterized by letting a computer implement the steps of reading image signals obtained by taking a subject, acquiring distance information that is information indicative of a distance up to said subject upon image taking, using position information indicative of a position of the pixel to be processed in an image represented by said image signals and said distance information to determine gray level transformation characteristics, and applying gray level transformation to said image signals depending on said gray level transformation characteristics.

(A) is embodied as the first embodiment shown in FIGS. 1 to 6, and the second embodiment shown in FIGS. 7 to 10. The “step of reading image signals obtained by taking a subject” that is a part of (A) is equivalent to processing for letting the computer read signals from CCD 104 of FIGS. 1 and 7 as unprocessed Raw data and image signals producing ISO sensitivity information, image size, etc. as header information. The “step of acquiring distance information that is information indicative of the distance up to said subject upon image taking” is equivalent to processing for letting the computer implement processing at the distance information acquisition unit 1100 of FIGS. 1 and 7. The “step of using position information indicative of a position of the pixel to be processed in an image represented by said image signals and said distance information to determine gray level transformation characteristics”, and the “step of applying gray level transformation to said image signals depending on said gray level transformation characterstics” are equivalent to processing for letting the computer implement processing at the transformation unit 111 of FIGS. 1 and 7.

(B) Another image signal processing program of the invention is characterized by letting a computer implement the steps of reading image signals obtained by taking a subject, acquiring distance information on a distance up to the subject, setting an area of interest in said image signals, using said distance information to figure out a correction coefficient regarding said area of interest, and using said correction coefficient to apply gray level transformation to said image signals.

(B) is embodied as the first and second embodiments shown in FIGS. 11 and 12. Referring to the architecture of (B), the “step of reading image signals obtained by taking a subject” is equivalent to processing at S2 in FIGS. 11 and 12; the “step of acquiring distance information on a distance up to the subject” is equivalent to processing at S1; the “step of setting an area of interest in said image signals” is equivalent to processing at S3; the “step of using said distance information to figure out a correction coefficient regarding said area of interest” is equivalent to processing at S5; and the “step of using said correction coefficient to apply gray level transformation to said image signals” is equivalent to processing at S6.

According to the invention, gray level transformation is implemented while independently varying gray level transformation characteristics for each pixel or for each area, so that there can be an image-taking apparatus and an image signal processing program provided, which are capable of generating good image signals. Especially when information other than image signals is used to make correction of the quantity of rim light in stroboscopic photography, good image signals can be generated with corrected luminance variations.

### BRIEF DESCRIPTION OF THE DRAWINGS

FIG. 1 is illustrative of the architecture of the first embodiment.

FIG. 2 is illustrative of the first architecture of the transformation unit 110 in the first embodiment.

FIG. 3 is illustrative of the second architecture of the transformation unit 110 in the first embodiment.

FIG. 4 is illustrative of the third architecture of the transformation unit 110 in the first embodiment.

FIG. 5 is illustrative of clipping in the first embodiment.

FIG. 6 is illustrative of how to extract an area of interest.

FIG. 7 is illustrative of the architecture of the second embodiment.

FIG. 8 is illustrative of the first architecture of the transformation unit 1002 in the second embodiment.

FIG. 9 is illustrative of the second architecture of the transformation unit 1002.

FIG. 10 is illustrative of the third architecture of the transformation unit 1002.

FIG. 11 is a flowchart for the first embodiment.

FIG. 12 is a flowchart for the second embodiment.

### BEST MODE FOR CARRYING OUT THE INVENTION

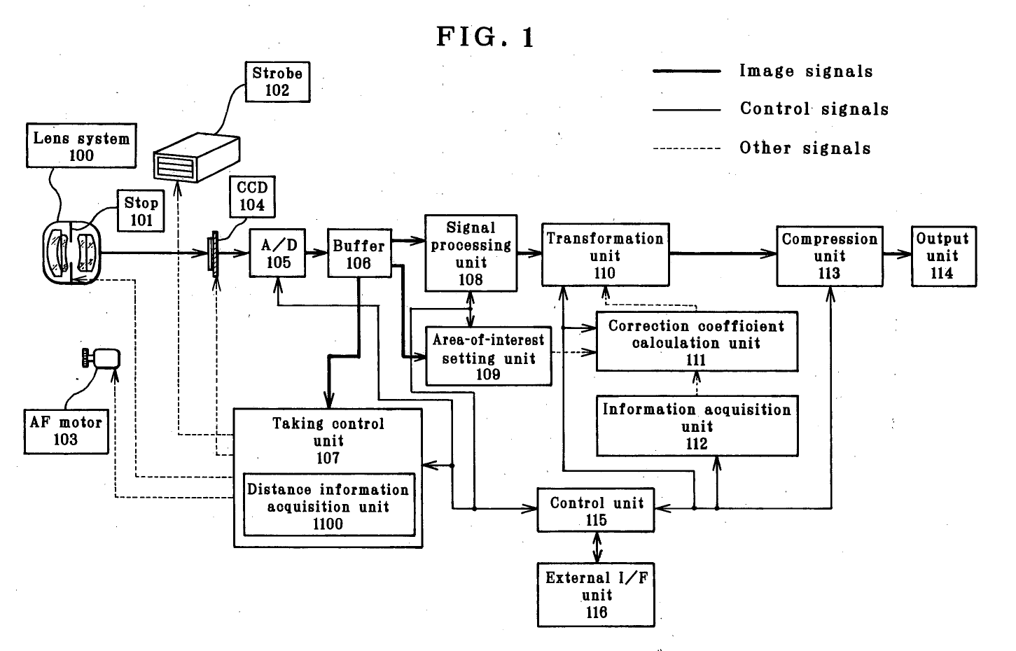

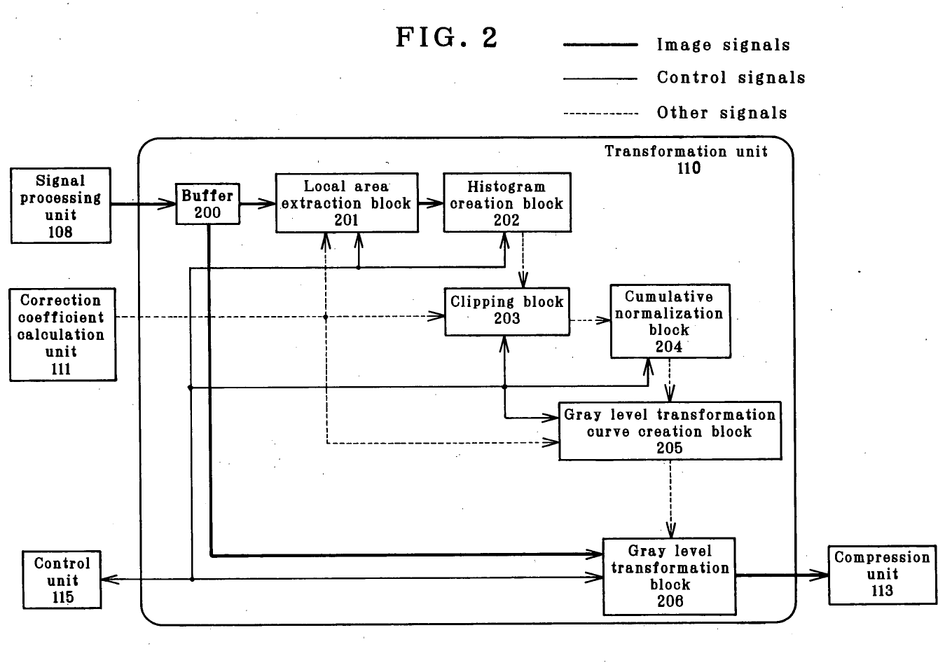

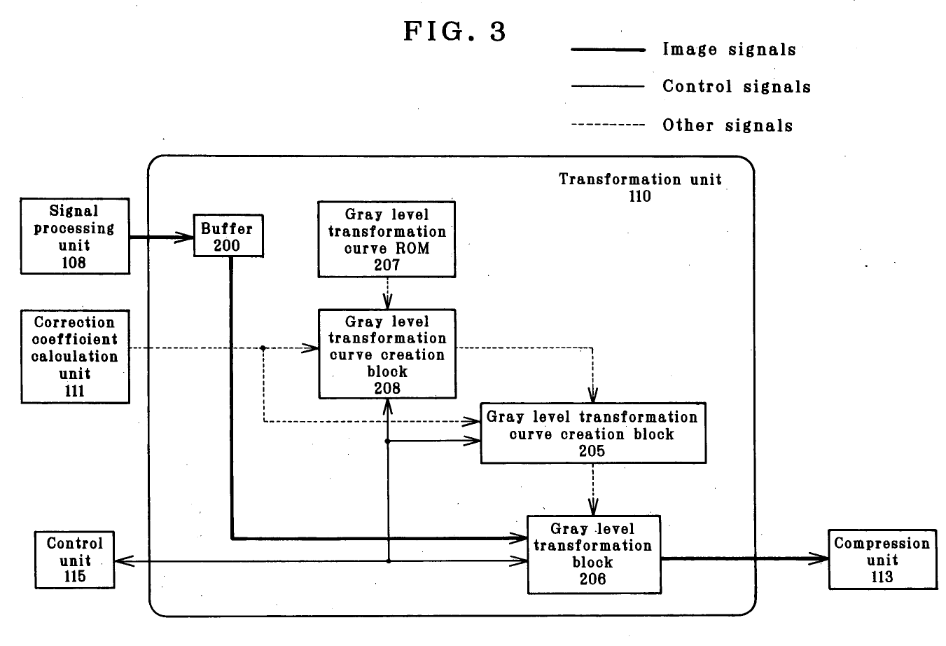

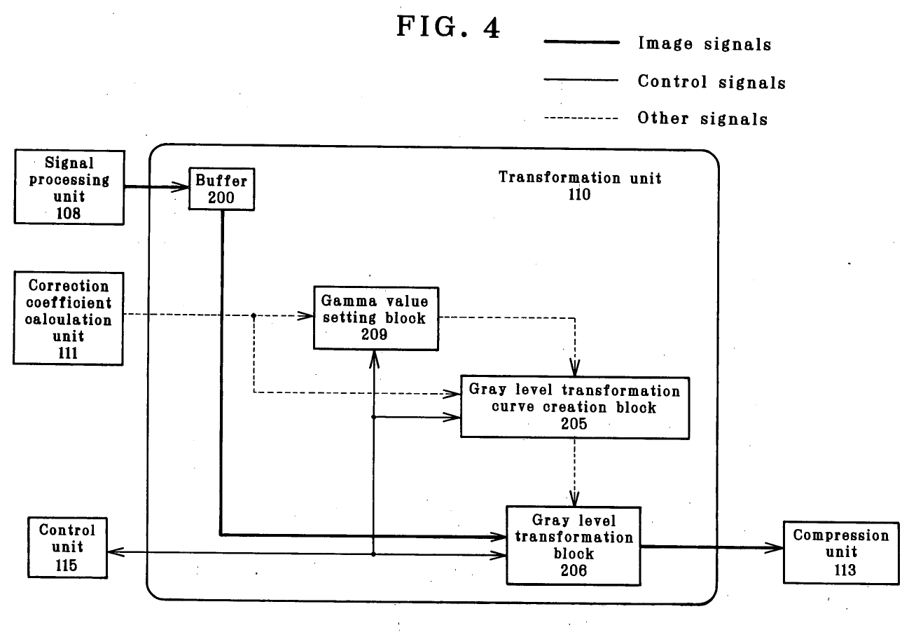

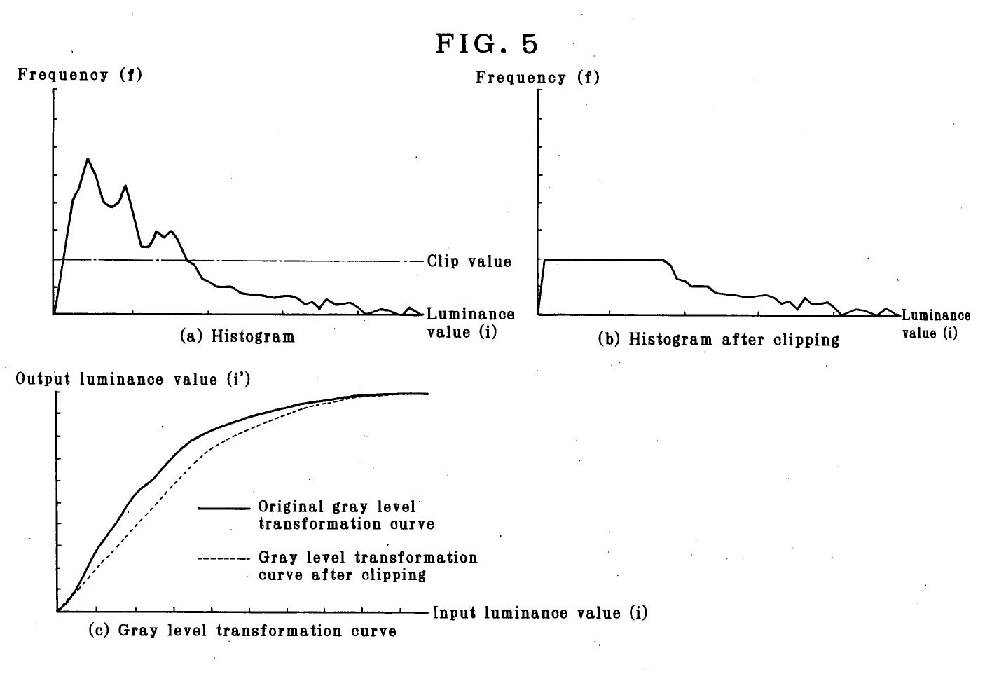

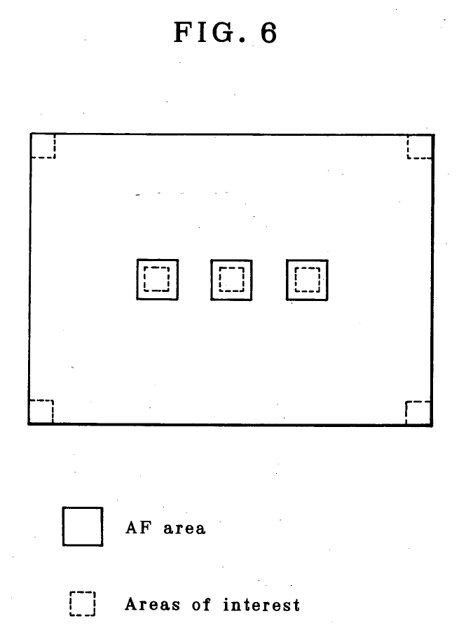

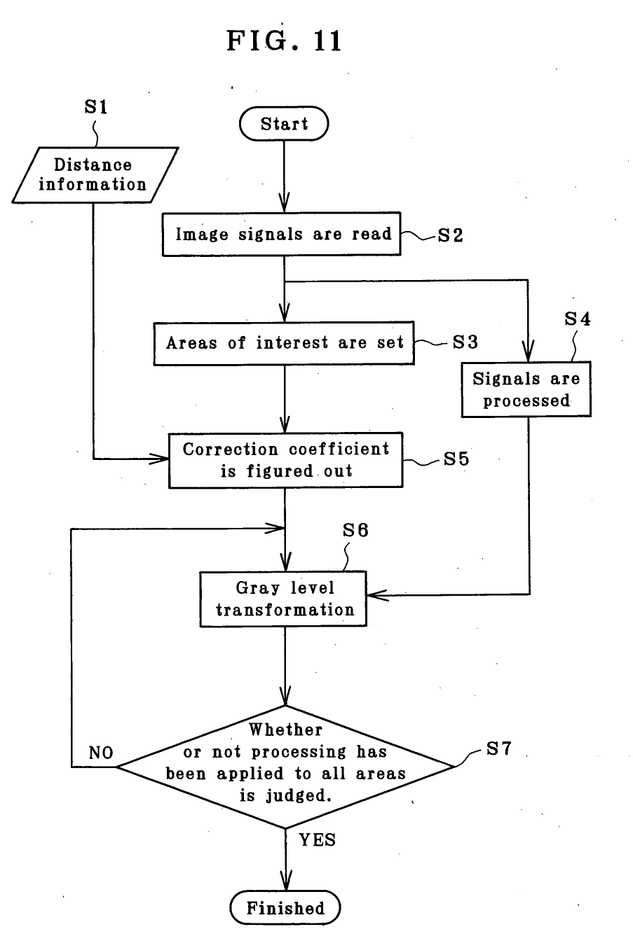

The first embodiment of the invention is now explained with reference to the drawings. The first embodiment is shown in FIGS. 1 to 6 and FIG. 11. More exactly, FIG. 1 is illustrative of the architecture of the first embodiment; FIG. 2 is illustrative of the first architecture of the transformation unit 110; FIG. 3 is illustrative of the second architecture of the transformation unit 110; FIG. 4 is illustrative of the third architecture of the transformation unit 110; FIG. 5 is illustrative of clipping; FIG. 6 is illustrative of how to extract an area of interest; and FIG. 11 is a flowchart.

FIG. 1 is illustrative of the architecture of the first embodiment. An image taken through the lens system 100, stop 101 and CCD 104 is converted at the A/D converter (often referred simply to as A/D in the disclosure and drawings) 105 into digital signals. The image signals from the A/D 105 are forwarded to the signal processing unit 108 via the buffer 106. Signals from the buffer 106 are also forwarded to the area-of-interest setting unit 109 and taking control unit 107. The area-of-interest setting unit 109 is connected to the correction coefficient calculation unit 111. The taking control unit 107 is connected to the stop 101, strobe 102, AF motor 103 and CCD 104. The signal processing unit 108 is connected to the transformation unit 110. The transformation unit 110 is connected to the compression unit 113 that is in turn connected to the output unit 114. The information acquisition unit 112 is connected to the correction coefficient calculation unit 111 that is in turn connected to the transformation unit 110. The control unit 115 such as a microcomputer is bidirectionally connected to the A/D 105, taking control unit 107, signal processing unit 108, area-of-interest setting unit 109, transformation unit 110, correction coefficient calculation unit 111, information acquisition unit 112 and compression unit 113. Further, the external I/F unit 116 comprising a power switch, a shutter button, and an interface for selecting modes upon image taking, too, is bidirectionally connected to the control unit 115.

How the signals flow in FIG. 1 is explained. After taking conditions such as ISO sensitivity and exposure are set via the external I/F unit 116, the shutter button (not shown) is half pressed down to put the apparatus into a pre-taking mode. Image signals taken via the lens system 100, stop 101 and CCD 104 are converted at the A/D 105 into digital signals which are then forwarded to the buffer 106. In the embodiment here, the CCD 104 is supposed to be a single-chip CCD based on the primary colors RGB, and the gray level width of signals by the A/D 105 is supposed to be 12 bits as an example. Image signals in the buffer 106 are forwarded to the taking control unit 107. The distance information acquisition block 1100 provided in the taking control unit 107 detects contrast information of the image signals within an AF area, and controls the AF motor 103 such that the detected contrast information reaches a maximum, thereby obtaining the focused signals. Depending on the state of the then lens system 100, a distance up to a subject at the focused position is determined so that it is acquired as distance information. Alternatively, the taking control unit 107 may operate to acquire no image signals in the pre-taking mode and, instead, use an external infrared sensor (not shown) to measure a distance up to a main subject and control the AF motor 103 depending on the ensuing measurement, thereby gaining distance information at the focused position. In either case, whenever there are plural AF areas, the distance is measured for each AF area: the distance information in all the AF areas is supposed to be figured out. At the taking control unit 107, the level of luminance in the signals, and a luminance sensor (not shown) are used to control the stop 101, the quantity of light emitted out of the strobe 102 and the electronic shutter speed of CCD 104 such that proper exposure is achievable.

Then, the shutter button (not shown) is full pressed down via the external I/F unit 116 to let the strobe 102 emit out light for a full taking mode. Stroboscopic image signals are forwarded to the buffer 106 as in the pre-taking mode. The full-taking mode is implemented based on the focusing conditions determined at the taking control unit 107 and the quantity of light emitted out of the strobe, and the information on the full-taking mode is forwarded to the control unit 115. Image signals in the buffer 106 are forwarded to the signal processing unit 108 and area-of-interest setting unit 109. The area-of-interest setting unit 109 extracts given areas of interest on the image signals forwarded from the buffer 106 on the basis of control at the control unit 115.

FIG. 6 is illustrative of how to extract areas of interest. As shown typically in FIG. 6, some portions in the AF area and areas at four corners of an image signal are extracted as the areas of interest. Based on control at the control unit 115, the signal processing unit 108 reads image signals in a single-chip state on the buffer 106 to generate image signals in a three-chip state which are already subjected to known interpolation, white balancing or the like, and then convert them into luminance signals and color difference signals that are in turn forwarded to the transformation unit 110. At the information acquisition unit 112, there is distance information acquired, which is contained in the image signals obtained at the taking control unit 107 via the control unit 115. At the correction coefficient calculation unit 111, a correction coefficient for determining gray level transformation characteristics is figured out based on the distance information forwarded from the information acquisition unit 112 via the control unit 115. At the transformation unit 110, the histogram of luminance signals forwarded from the signal processing unit 108 and the correction coefficient figured out at the correction coefficient calculation unit 111 are used to set a gray level transformation curve as the gray level transformation characteristics, with which gray level transformation is applied to the luminance signals. The color difference signals, and the luminance signals after gray level transformation is applied to them are forwarded to the compression unit 113 at which compression processing such as known JPEG is implemented, and the ensuing compression signals are forwarded to the output unit 114 at which the compression signals are recorded and stored in a memory card or the like.

FIG. 2 is illustrative of one example of the architecture of the transformation unit 110. The transformation unit 110 is built up of a buffer 200, a local area extraction block 201, a histogram creation block 205, a clipping block 203, a cumulative normalization block 204, a gray level transformation curve creation block 205 and a gray level transformation block 206. The signal processing unit 108 is connected to the buffer 200, and the buffer 200 is connected to the local area extraction block 201 and gray level transformation block 206. The correction coefficient calculation unit 111 is connected to the local area extraction block 201, and the local area extraction block 201 is connected to the histogram creation block 202. The histogram creation block 202, and the correction coefficient calculation unit 111 is connected to the clipping block 203, and the clipping block 203 is connected to the cumulative normalization block 204. The cumulative normalization block 204 is connected to the gray level transformation curve creation block 205.

The gray level transformation curve creation block 205 is connected to the gray level transformation block 206, and the gray level transformation block 206 is connected to the compression unit 113. The control unit 115 is bidirectionally connected to the local area extraction block 201, histogram creation block 202, clipping block 203, cumulative normalization block 204, gray level transformation curve creation block 205 and gray level transformation block 206. The luminance signals and color difference signals forwarded from the signal processing unit 108 are stored in the buffer 200. The local area extraction block 201 extracts a rectangular area of given size from the area of interest with each pixel as center, for instance, a local area of 16×16 pixel unit. The histogram creation block 202 creates a histogram for each local area, forwarding it to the clipping block 203.

The clipping block 203 uses the information from the correction coefficient calculation unit 111 to apply clipping to the histogram from the histogram creation block 202. FIG. 5 is illustrative of clipping: in FIG. 5(a) with luminance value as abscissa and frequency as ordinate, there are plotted a histogram of the local area figured out of the histogram creation block 202 and a clip value, in FIG. 5(b) with luminance value as abscissa and frequency as ordinate, there is plotted a histogram wherein a frequency greater than the clip value is replaced by the clip value by way of clipping, and in FIG. 5(c) with input luminance value as abscissa and output luminance value as ordinate, there is plotted a gray level transformation curve obtained by the accumulation and normalization of the original histogram and the post-clipping histogram.

Here let i′ and i stand for the output and input luminance values, respectively. The post-clipping gray level transformation curve comes more closely to the straight line of i′=i than the original gray level transformation curve. In other words, when the clip value upon clipping is set small as the output luminance value draws near to a state where it is invariable with respect to the input luminance value, a difference between the output luminance value and the input luminance value becomes small. As the clip value is set a bit higher, on the other hand, the difference between the output and input luminance values grows large. In the example here, for instance, the clip value C is figured out of the following equation (1).

C=k(xₒₖ,yₒₖ,zₒₖ) (1)

Here, k(xₒₖ, yₒₖ, zₒₖ) is indicative of a correction coefficient at coordinates (xₒₖ, yₒₖ, zₒₖ) containing the distance information of the area of interest figured out at the correction coefficient calculation unit 111 where k=1, . . . , n. Suppose here that there are n areas of interest. The correction coefficient k(xₒₖ, yₒₖ, zₒₖ), for instance, is represented by equation (2).

k(xₒₖ,yₒₖ,zₒₖ)=a(xₒₖ−x_{c})+b(yₒₖ−y_{c})+czₒₖ (2)

Here, a, b, and c is indicative of a given constant, and (x_{c}, y_{c}) is indicative of center coordinates for an image signal. When the coordinates for the subject at the area of interest are near the center coordinates or their distance with respect to the taking apparatus is short, the clip value becomes low and the difference between the output and input luminance values becomes small. When the coordinates for the subject at the area of interest are far away from the center coordinates or their distance with respect to the taking apparatus is long, on the other hand, the clip value grows large and the difference between the input and output luminance values grows large. The characteristics equation for the clip value is never limited to equations (1) and (2) with the proviso that it can provide such characteristics.

In the embodiment here, the more away the area of interest is from the center of the image signal and the taking apparatus, the larger the gain value for the input luminance value grows so that the decrease in the quantity of light upon stroboscope photography can be held back. In the embodiment here, there is no distance information acquired by the already implemented processing in the four corner regions of the area of interest other than the AF area; a predetermined value is acquired as the value of z that is distance information with respect to the taking apparatus for areas of interest other than said AF area. That is, other than the AF area, equation (2) becomes equation (3).

k(xₒₖ,yₒₖ,A)=a(xₒₖ−x_{c})+b(yₒₖ−y_{c})+cA (3)

Here A is indicative of a given constant. When it comes to portrait photography or the like, the distance between the four corners of an image signal and the taking apparatus is greater than that between a main subject in the AF area and the taking apparatus: the constant A is set a bit greater. When it comes to background photography or the like, that distance is nearly equal to the distance between a main subject in the AF area and the taking apparatus: the constant A is set at the same value as the distance in the AF area. When it comes to portrait photography or the like, that distance is shorter than the distance between a main subject in the AF area and the taking apparatus upon focusing on the background, that distance is smaller than that between a main subject in the AF area and the taking apparatus: the constant A is set a bit smaller. The constant A may as well be set by the user depending on scenes such as figures or landscapes. The histogram subjected to clipping is forwarded to the cumulative normalization block 204. The cumulative normalization block 204 accumulates histograms into a cumulative histogram, and normalizes it in conformity with the gray level width thereby generating a gray level transformation curve.

In the embodiment here where the gray level width of an image signal is supposed to be 12 bits, the aforesaid gray level transformation curve is 12 bits input/12 bit output. The aforesaid gray level transformation curve is forwarded to the gray level transformation curve creation block 205 at which a gray level transformation curve for all pixels of the image signal is figured out on the basis of the aforesaid gray level transformation curve for a plurality of areas obtained at the cumulative normalization block 204. Let tₒₖ(i) be the average of gray level transformation curves at a certain area of interest. A gray level transformation curve for a pixel at coordinates (x, y) in the image signal is given by equation (4), using center coordinates (xₒₗ, yₒₗ), (xₒₘ, yₒₘ) for two areas of interest near to the coordinates (x, y) and gray level transformation curves tₒᵢ(i), tₒₘ(i).

$${t}_{( x , y )} ( i ) = \frac{{d}_{{o}_{i}} {t}_{{o}_{i}} ( i ) + {d}_{{o}_{m}} {t}_{{o}_{m}} ( i )}{{d}_{{o}_{i}} + {d}_{{o}_{m}}} \\ {d}_{{o}_{i}} = \sqrt{{( x - {x}_{{o}_{i}} )}^{2} + {( y - {y}_{{o}_{i}} )}^{2}} \\ {d}_{{o}_{m}} = \sqrt{{( x - {x}_{{o}_{m}} )}^{2} + {( y - {y}_{{o}_{m}} )}^{2}} \qquad ( 4 )$$

It is noted that for gray level transformation curve creation, there may be three more areas of interest used. For instance, when there are three areas of interest, a gray level transformation curve for the third is given by equation (5), using the center coordinates (xₒₚ, yₒₚ) in the third area of interest and a gray level transformation curve tₒₚ(i).

$${t}_{( x , y )} ( i ) = \frac{{d}_{{o}_{i}} {t}_{{o}_{i}} + {d}_{{o}_{m}} {t}_{{o}_{m}} ( i ) + {d}_{{o}_{p}} ( i )}{{d}_{{o}_{i}} + {d}_{{o}_{m}} + {d}_{{o}_{p}}} \\ {d}_{{o}_{i}} = \sqrt{{( x - {x}_{{o}_{i}} )}^{2} + {( y - {y}_{{o}_{i}} )}^{2}} \\ {d}_{{o}_{m}} = \sqrt{{( x - {x}_{{o}_{m}} )}^{2} + {( y - {y}_{{o}_{m}} )}^{2}} \\ {d}_{{o}_{p}} = \sqrt{\text{(} x - {x}_{{o}_{p}} {\text{)}}^{2} + \text{(} y - {y}_{{o}_{p}} {\text{)}}^{2}} \qquad ( 5 )$$

The calculated gray level transformation curve for each pixel is forwarded to the gray level transformation block 206. The gray level transformation block 206 applies gray level transformation to each pixel on the buffer 200 based on the gray level transformation curve from the gray level transformation curve creation block 205, after which division is implemented in such a way as to fit for the gray level width upon output (here supposed to be 8 bits). The 8-bit image signal is forwarded to the compression unit 113.

In the example mentioned above, the gray level transformation curve based on the histogram of the local area is figured out; however, the invention is not necessarily limited to it. As shown typically in FIG. 4, it is also possible to use a gamma value. In FIG. 4, the local area extraction block 201, histogram creation block 202, clipping block 203 and cumulative normalization block 204 are removed from the architecture of the trans-formation unit 110 shown in FIG. 2 and, instead, a gamma value setting block 209 is added to it. The basic architecture is equivalent to that of the transformation unit 110 shown in FIG. 2, with like names and like numerals given to like blocks.

Only blocks of the architecture different from those of FIG. 2 are now explained. The correction coefficient calculation unit 111 is connected to the gamma value setting block 209 that is in turn connected to the gray level transformation curve creation block 205. The control unit 115 is bidirectionally connected to the gamma value setting block 209. The gamma value setting block 209 sets the gamma value used for gray level transformation, based on the information from the correction coefficient calculation unit 111. The gamma value y at certain coordinates (xₒₖ, yₒₖ, zₒₖ) in the area of interest figured out at the correction coefficient calculation unit 111 where k=1, . . . , n is set as given by equation (6).

γ=a′(xₒₖ−x_{c})+b′(yₒₖ−y_{c})+c′zₒₖ (6)

Here, a′, b′, and c′ is indicative of a given constant. Equation (6) is used to implement gray level trans-formation as represented by equation (7).

i′=i^{γ} (7)

When the coordinates for a subject at the area of interest are near the center coordinates or their distance with the taking apparatus is short, the gamma value becomes small and the difference between the output and input luminance values becomes small. When the coordinates for a subject at the area of interest are far away from the center coordinates or their distance with the taking apparatus grows long, on the other hand, the gamma value grows large and the difference between the output and input luminance values grows large. That is, the more away the area of interest is from the center of the image signal and the taking apparatus, the greater the gain value with respect to the input luminance value grows so that the decrease in the quantity of light upon stroboscopic photography can be held back. The characteristics equation for the gamma value is never limited to equation (6) with the proviso that it can provide such characteristics.

In the embodiment here, there is no distance information acquired by the already implemented processing in four corner regions of the area of interest other than the AF area; for the area of interest other than said AF area, a predetermined value is acquired as the value of z that is distance information with the taking apparatus. That is, other than the AF area, the gamma value is given by equation (8).

γ=a′(xₒₖ−x_{c})+b′(yₒₖ−y_{c})+c′B (8)

Here B is indicative of a given constant. Often, the distance between the four corners of the image signal and the taking apparatus is longer that that between a main subject in the AF area and the taking apparatus: the constant B is set a bit larger. The gray level transformation curve creation block 205 figures out the gamma value for all pixels of the image signal based on the gamma values for a plurality of areas obtained at the gamma value setting block 209.

Here let γₒₖ(i) be the average of gamma values at a certain area of interest. A gamma value γ(x, y) (i) for a pixel at the coordinates (x, y) in an image signal is represented by equation (9), using the center coordinates (xₒₗ, yₒₗ), (xₒₘ, yₒₘ) for two areas of interest near the coordinates (x, y) and gamma values γₒₗ(i), γₒₘ(i).

$${γ}_{( x , y )} ( i ) = \frac{{d}_{{o}_{i}} {γ}_{{o}_{i}} ( i ) + {d}_{{o}_{m}} {γ}_{{o}_{m}} ( i )}{{d}_{{o}_{i}} + {d}_{{o}_{m}}} \\ {d}_{{o}_{i}} = \sqrt{{( x - {x}_{{o}_{i}} )}^{2} + {( y - {y}_{{o}_{i}} )}^{2}} \\ {d}_{{o}_{m}} = \sqrt{{( x - {x}_{{o}_{m}} )}^{2} + {( y - {y}_{{o}_{m}} )}^{2}} \qquad ( 9 )$$

As a matter of course, there may be three more areas of interest used for the calculation of gamma values.

It is also possible to use a preset gray level transformation curve as shown in FIG. 3. In FIG. 3, the local area extraction block 201, histogram creation block 202, clipping block 203 and cumulative normalization block 204 are removed from the architecture of the trans-formation unit 110 shown in FIG. 2 and, instead, the gray level transformation curve ROM 207 and gray level transformation curve setting block 208 are added to it. The basic architecture is equivalent to that of the transformation unit 110 shown in FIG. 2, with like names and like numerals given to like blocks.

Only blocks of the architecture different from those of FIG. 2 are now explained. The correction coefficient calculation unit 111 is connected to the gray level transformation curve setting block 208 that is in turn connected to the gray level transformation creation block 205. The control unit 115 is bidirectionally connected to the gray level transformation curve setting block 208. On the basis of the information from the correction coefficient calculation unit 111, the gray level transformation curve setting block 208 sets a gray level transformation curve read out of the gray level transformation curve ROM 207. Suppose now that the correction coefficient is given by equations (2) and (3), for instance. When the value of the correction coefficient is small, the gray level transformation curve creation block 205 sets a gray level transformation curve that has a small gain value with respect to the input luminance value, and when the value of the correction coefficient is large, it sets a gray level transformation curve that has a large gain value with respect to the input luminance value, thereby figuring out gray level transformation curves for all pixels of the image signal by the aforesaid method.

By using information other than image signals, it is thus possible to hold back the decrease in the quantity of light by stroboscopic photography, thereby obtaining good image signals. By use of the ROM, it is possible to make do with figuring out histograms, thereby achieving fast processing. The use of gamma values contributes to memory capacity decreases.

In the embodiment as described above, processing is supposed to run on hardware; however, the invention is never limited to it. For instance, signals from the CCD 104 may be produced as unprocessed Raw data and ISO sensitivity information, image size, etc. may be produced as header information for separate processing on software. FIG. 11 is a flowchart for software in the first embodiment. At S1 distance information is acquired, at S2 header information containing information about ISO sensitivity, image size, etc. is read, and at S3 an area of interest is set. At S4 given image processing is applied to image signals, and at S5 a correction coefficient is figured out using the distance information. At S6 gray level transformation is implemented using the above correction coefficient, and at S7 whether or not processing has been applied to all pixels is judged, and if yes, the whole processing is finished.

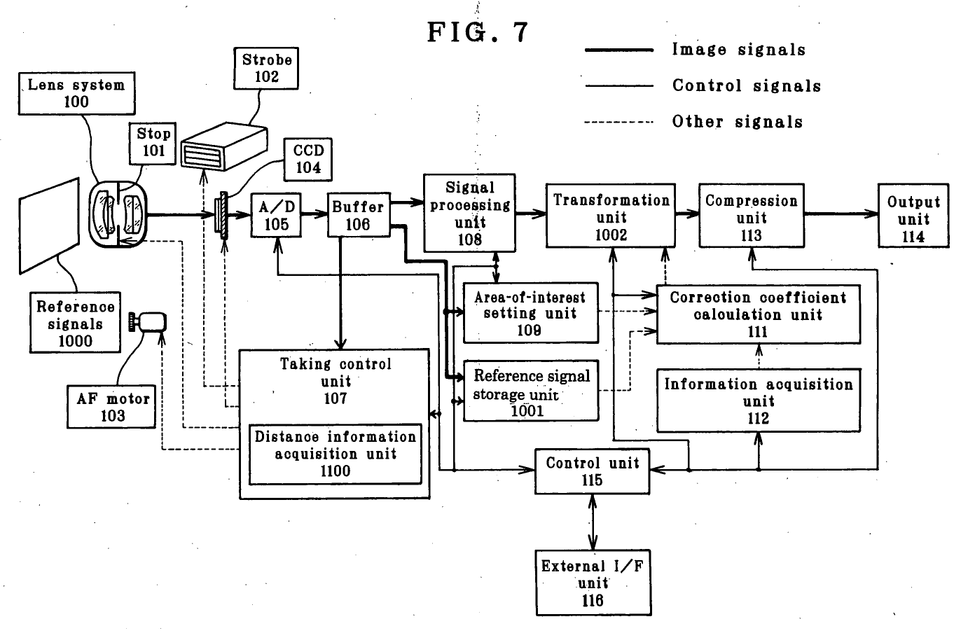

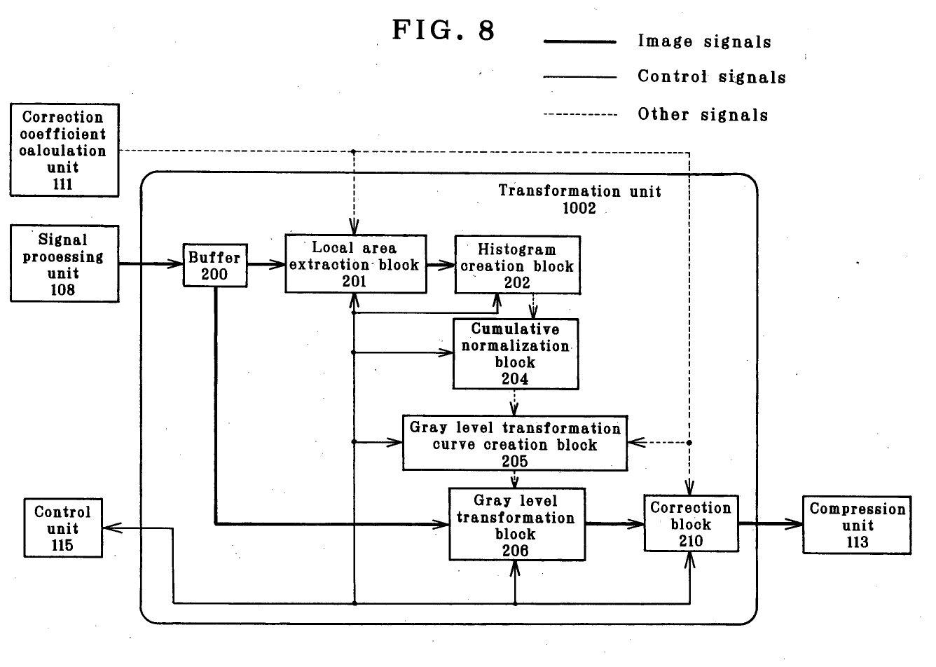

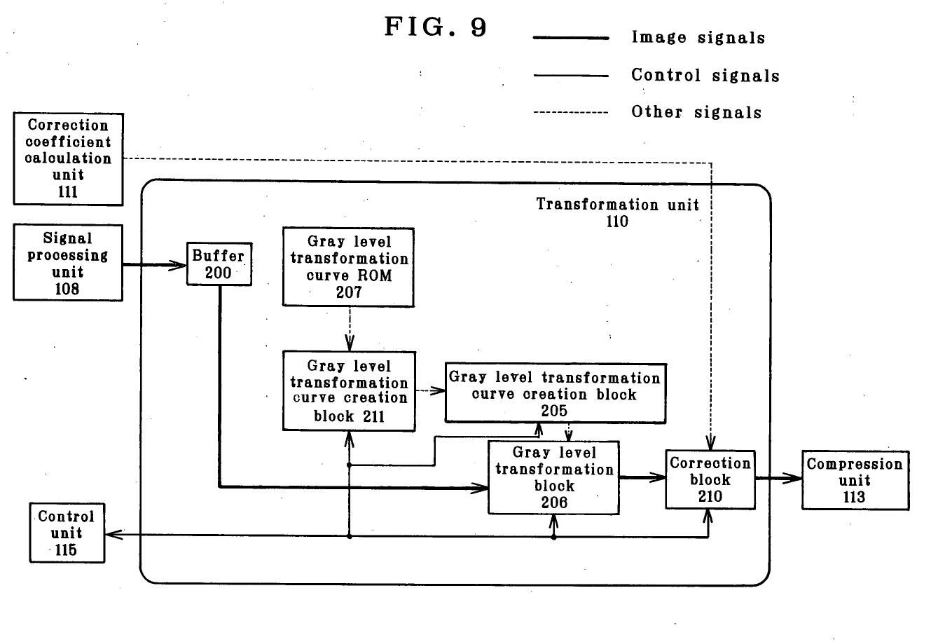

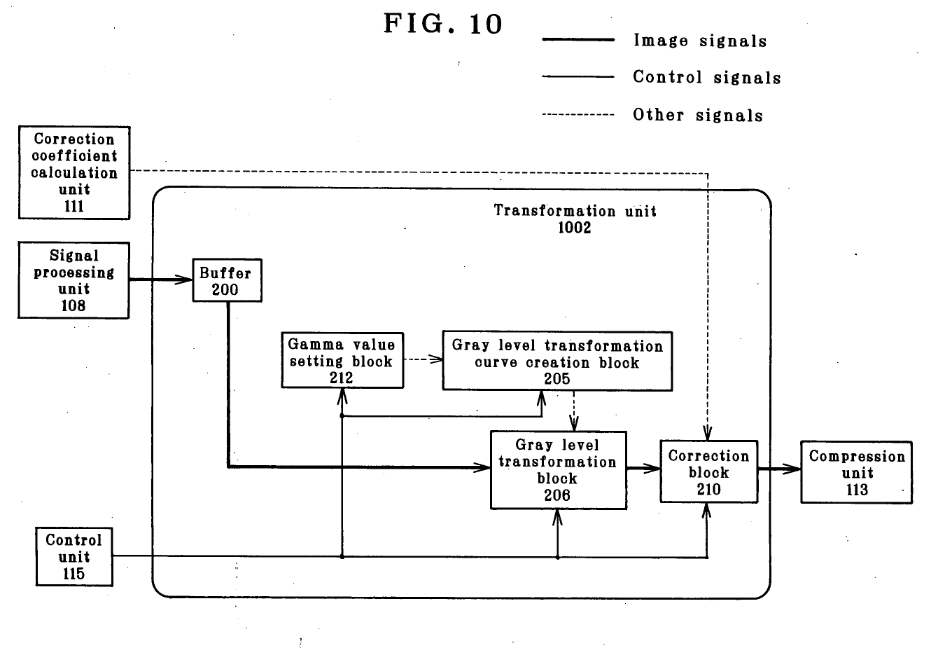

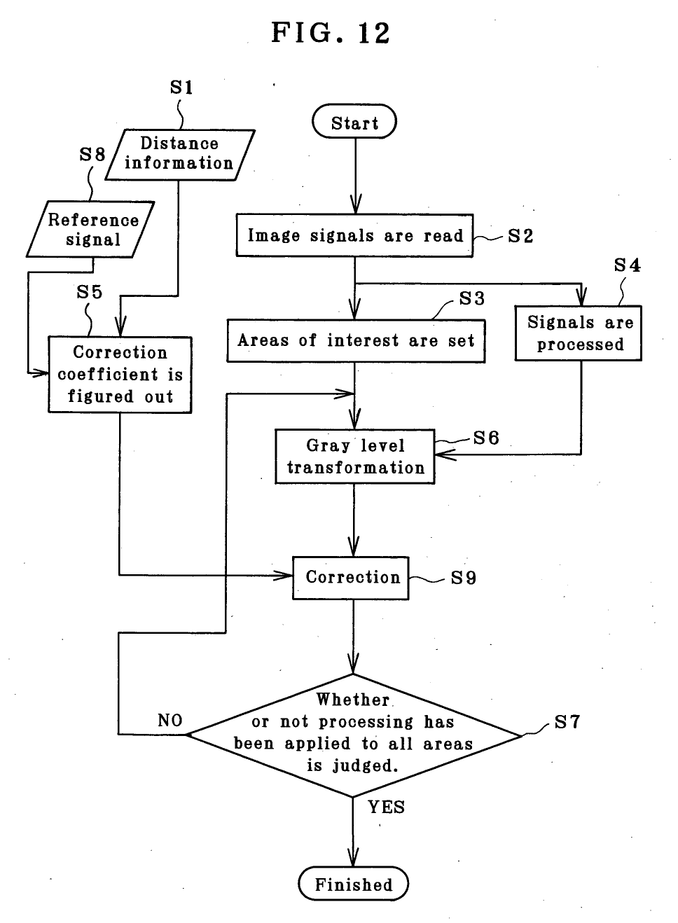

FIGS. 7 to 10 and FIG. 12 are illustrative of the second embodiment: FIG. 7 is illustrative of the architecture of the second embodiment of the invention, FIG. 8 is illustrative of the architecture of the transformation unit 1002, FIG. 9 is illustrative of the second architecture of the transformation unit 1002, FIG. 10 is illustrative of the third architecture of the transformation unit 1002, and FIG. 12 is a flowchart.

The second embodiment of the invention is now explained. FIG. 7 is illustrative of the architecture of the second embodiment, with like names and like numerals given to like units and blocks as in the first embodiment. Now blocks and units different from those of the first embodiment are primarily explained. Reference signals 1000 taken via the lens system 100, stop 101 and CCD 104 are converted at the A/D 105 into digital signals. The buffer 106 is connected to the reference signal storage unit 1001. The reference signal storage unit 1001 is connected to the correction coefficient calculation unit 111, and the signal processing unit 108 and correction coefficient calculation unit 111 are connected to the transformation unit 1002. The transformation unit 1002 is connected to the compression unit 113, and the control unit 115 such as a microcomputer is bidirectionally connected to the reference signal storage unit 1001 and transformation unit 1002.

Operation of the second embodiment different from that of the first embodiment is now explained. First, a reference signal taking mode is set via the external I/F unit 116. After taking conditions such as ISO sensitivity and exposure are set, the shutter button (not shown) is full pressed down to let the strobe 102 to emit out light and take the reference signals 1000. For the reference signals, signals such as gray charts with a constant reflectivity in the taking area may be used. The thus taken reference signals 1000 are forwarded to the reference signal storage unit 1001 via the buffer 106.

Then, the full-taking mode is set via the external I/F unit 116 for stroboscopic photography of a subject. Image signals of the thus taken subject are forwarded to the signal processing unit 108 via the buffer 106. At the transformation unit 1002, a gray level transformation curve is set using a correction coefficient figured out at the correction coefficient calculation unit 111 to apply gray level transformation to luminance signals of the image signals.

FIG. 8 is illustrative of one example of the architecture of the transformation unit 1002. In FIG. 8, the clipping block 203 is removed from the architecture of the transformation block 110 of FIG. 2 and, instead, the correction block 210 is added to it. The basic architecture is equivalent to that of the transformation unit 110 of FIG. 2, with like names and like numerals given to like blocks. Blocks different from those of FIG. 2 are now explained. The correction coefficient calculation unit 111 and gray level transformation block 206 are connected to the correction block 210 that is in turn connected to the compression block 113, and the control unit 115 is bidirectionally connected to the correction block 210. On the basis of information from the correction coefficient calculation block 210 corrects each pixel for the image signal after gray level transformation.

When the correction coefficient is given by equation (2) or (3) for instance, post-correction signals are obtained by multiplying each pixel of the image signal by the above correction coefficient. Note however that coefficients a, b and c are adjusted such that the maximum value of the correction coefficient becomes 1 for instance. When the coordinates for each pixel are near the center coordinates or their distance with the taking apparatus is short, the correction value becomes small, letting gray level transformation take less effect. When the coordinates for the subject at the area of interest are far away from the center coordinates or their distance with the taking apparatus is long, by contrast, the correction value draws nearer to 1, letting gray level transformation take effect.

When the reference signals are used, the correction coefficient may also be set as given by equation (10).

$$k ( {x}_{{o}_{k}} , {y}_{{o}_{k}} , {z}_{{o}_{k}} ) = α \frac{{i}_{r} ( {x}_{c} , {y}_{c} )}{{i}_{r} ( {x}_{{o}_{k}} , {y}_{{o}_{k}} )} + β {z}_{{o}_{k}} \qquad ( 10 )$$

Here iᵣ(x_{c}, y_{c}) is a luminance value at a center site of the reference signal, iᵣ(xₒₖ, yₒₖ) is a luminance value at certain coordinates (xₒₖ, yₒₖ, zₒₖ) at the area of interest of the reference signal, and a and b stand for given constants. From equation (10) or by use of the spatial distribution of luminance values of the reference signal it is possible to make correction of luminance variations. In the embodiment here, there is no distance information acquired by the already implemented processing in the four corner regions of the area of interest other than the AF area; a predetermined value is acquired as the value of z that is distance information with respect to the taking apparatus for areas of interest other than said AF area. That is, other than the AF area, the correction value becomes equation (11).

$$k ( {x}_{{o}_{k}} , {y}_{{o}_{k}} , B ) = α \frac{{i}_{r} ( {x}_{c} , {y}_{c} )}{{i}_{r} ( {x}_{{o}_{k}} , {y}_{{o}_{k}} )} + β B \qquad ( 11 )$$

Here B is indicative of a given constant. Often, the distance between the four corners of the image signal and the taking apparatus is longer than the distance between a main subject in the AF area and the taking apparatus: the constant B is set a bit larger. On the basis of the correction coefficient obtained at the correction coefficient calculation unit 111, the correction block 210 figures out the correction coefficient for all pixels of the image signal.

Suppose here that ⁻kₒₖ is the average of correction coefficients at a certain area of interest. Then, a correction value for a pixel at coordinates (x, y) in the image signal is figured out, as given by equation (12), using center coordinates (xₒₗ, yₒₗ), (xₒₘ, yₒₘ) and correction coefficients ⁻kₒₗ, ⁻kₒₘ.

$$k ( x , y ) = \frac{{d}_{{o}_{l}} {\overline{k}}_{{o}_{l}} + {d}_{{o}_{m}} {\overline{k}}_{{o}_{m}}}{{d}_{{o}_{l}} + {d}_{{o}_{m}}} \\ {d}_{{o}_{l}} = \sqrt{{( x - {x}_{{o}_{l}} )}^{2} + {( y - {y}_{{o}_{l}} )}^{2}} \\ {d}_{{o}_{m}} = \sqrt{{( x - {x}_{{o}_{m}} )}^{2} + {( y - {y}_{{o}_{m}} )}^{2}} \qquad ( 12 )$$

Using the correction value figured out of equation (12), the correction block 210 corrects each pixel for the image signal after gray level transformation.

In the example mentioned above, the gray level transformation curve based on the histogram of the local area is figured out; however, the invention is not necessarily limited to it. As shown typically in FIG. 10, it is also possible to use a gamma value. In FIG. 10, the gamma value setting block 209 is removed from the architecture of the transformation unit 110 shown in FIG. 4 and, instead, the gamma value setting block 211 and correction block 210 are added to it, with like names and like numerals given to like blocks. Only blocks different from those of FIG. 4 are explained.

The gamma value setting block 212 is connected to the gray level transformation curve creation block 205, and the correction coefficient calculation unit 111 and the gray level transformation block are connected to the correction block 210. The control unit 115 is bidirectionally connected to the gamma value setting block 212 and correction block 210. On the basis of control at the control unit 115, the gamma value setting block 212 sets a gamma value used for gray level transformation. For the gamma value, a reference gamma value such as a display gamma is set. Thereafter, each pixel after gray level transformation is corrected at the correction block 210.

As shown in FIG. 9, it is also possible to use a preset gray level transformation curve. In FIG. 9, the gray level transformation curve setting block 208 is removed from the architecture of the transformation unit 110 shown in FIG. 3 and, instead, the gray level transformation curve setting block 211 and correction block 210 are added to it. The basic architecture is equivalent to that of the transformation unit 110 shown in FIG. 3, with like names and like numerals given to like blocks.

Only blocks of the architecture different from those of FIG. 3 are now explained. The gray level transformation curve ROM 207 is connected to the gray level transformation curve setting block 211 that is in turn connected to the gray level transformation curve creation block 205. The correction coefficient calculation unit 111, and the gray level transformation block 206 is connected to the correction block 210, and the control unit 115 is bidirectionally connected to the gray level transformation curve creation block 211 and the correction block 210. Based on control at the control unit 115, the gray level transformation curve setting block 211 sets a gray level transformation curve read out of the gray level transformation curve ROM 207. The gray level transformation curve sets a reference gray level transformation curve like the above gamma transformation curve. Thereafter, each pixel after gray level transformation is corrected at the correction block 210.

By letting the gray level transformation curve of each pixel take effect, it is thus possible to hold back the decrease in the quantity of light by stroboscopic photography, thereby obtaining good image signals. By use of the reference signal, it is possible to pre-calculate the light quantity ratio involved, thereby making precise correction.

In the embodiment as described above, processing is supposed to run on hardware; however, the invention is never limited to it. For instance, signals from the CCD 104 may be produced as unprocessed Raw data and ISO sensitivity information, image size, etc. may be produced as header information for separate processing on software. FIG. 12 is a flowchart for software in the second embodiment. The same processing as in the flowchart of the second embodiment shown in FIG. 1 is indicated by the same capital (S). At S distance information is acquired and at S8 the reference signal is acquired. At S2 header information containing information about ISO sensitivity, image size, etc. is read, and at S3 an area of interest is set. At S4 given image processing is applied to image signals, and at S5 a correction coefficient is figured out using the distance information. At S6 gray level transformation is implemented using the above correction coefficient, and at S9 correction is implemented using the above correction coefficient. At S7 whether or not processing has been applied to all pixels is judged, and if yes, the whole processing is finished.

### INDUSTRIAL APPLICABILITY

In accordance with the invention as described above, it is possible to provide a taking apparatus and an image signal processing program capable of applying gray level transformation to image signals while independently varying gray level transformation characteristics for each pixel or each area. In particular, it is possible to provide a taking apparatus and an image signal processing program capable of using information other than image signals to correct the quantity of rim light in stroboscopic photography, thereby generating good image signals.

1. An image-taking apparatus adapted to apply gray level transformation to image signals obtained by taking a subject, comprising:
a distance information acquisition means for acquiring distance information that is information indicative of a distance up to the subject upon taking operation,
a gray level transformation characteristics setting means for using position information indicative of a position of a pixel to be processed in an image represented by said image signals and said distance information to determine gray level transformation characteristics, and
a gray level transformation means for applying gray level transformation to said image signals depending on said gray level transformation characteristics.

2. The image-taking apparatus according to claim 1, wherein said gray level transformation characteristics setting means determines said gray level transformation characteristics depending on a distance from a reference position in said image up to said position of a pixel to be processed.

3. The image-taking apparatus according to claim 1, wherein said gray level transformation characteristics setting means determines gray level transformation characteristics in such a way that the nearer said position of a pixel to be processed in said image is to the center of said image, the smaller a difference between an input value and an output value becomes.

4. The image-taking apparatus according to claim 1, wherein said gray level transformation characteristics setting means determines gray level transformation characteristics in such a way that the shorter a distance thereof with said subject at said position of a pixel to be processed in said image is, the smaller a difference between an input value and an output value becomes.

5. The image-taking apparatus according to claim 1, wherein said distance information acquisition means acquires, as said distance information, information that is indicative of a distance up to said subject corresponding to a focusing position upon taking.

6. The image-taking apparatus according to claim 1, further comprising a reference signal recording means for recording a reference signal beforehand that is an image signal obtained by stroboscopic photography, and wherein said gray level transformation characteristics setting means uses said reference signal to determine said gray level transformation characteristics.

7. The image-taking apparatus according to claim 6, wherein said gray level transformation characteristics setting means uses a signal ratio at different sites in an image represented by said reference signal and said distance information to determine said gray level transformation characteristics.

8. The image-taking apparatus according to claim 1, wherein said distance information acquisition means acquires, as said distance information, information that is indicative of a distance up to said subject at an area of interest in an image obtained by taking said subject.

9. The image-taking apparatus according to claim 8, wherein said distance information acquisition means acquires said distance information with respect to a plurality of said areas of interest, wherein a part of said areas of interest is an area corresponding to a focusing position upon image taking, and another part of said areas of interest is an area different from the area corresponding to a focusing position upon image taking.

10. The image-taking apparatus according to claim 8, wherein said gray level transformation characteristics setting means uses said distance information and said position information to determine gray level transformation characteristics at said area of interest, and uses gray level transformation characteristics at said area of interest to determine gray level transformation characteristics at a pixel position other than said area of interest.

11. The image-taking apparatus according to claim 8, further comprising a gray level transformation curve retention means for retaining plural types of preset gray level transformation characteristics, and wherein said gray level transformation characteristics setting means selects gray level transformation characteristics at said area of interest from among said plural types of gray level transformation characteristics on the basis of said distance information and said position information.

12. The image-taking apparatus according to claim 8, wherein said gray level transformation characteristics setting means uses said distance information and said position information to determine gray level transformation characteristics at said area of interest in at least two sites, and uses gray level transformation characteristics at said area of interest to determine gray level transformation characteristics at a pixel position other than said area of interest.

13. The image-taking apparatus according to claim 8, wherein said gray level transformation characteristics setting means comprises a histogram calculation means for figuring out a histogram of an area near a pixel of interest in said area of interest and a clipping means for applying clipping to said histogram, and wherein said gray level transformation characteristics are determined on the basis of a histogram after said clipping.

14. The image-taking apparatus according to claim 8, wherein said gray level transformation characteristics setting means sets, on the basis of said distance information and said position information, a gamma value of a gray level transformation curve represented by said gray level transformation characteristics at said area of interest, thereby determining said gray level transformation characteristics.

15. The image-taking apparatus according to claim 8, wherein said gray level transformation characteristics setting means comprises a coefficient calculation means for figuring out a coefficient regarding said area of interest, and wherein said coefficient is used to determine said gray level transformation characteristics.

16. The image-taking apparatus according to claim 8, wherein said distance information acquisition means is to acquire said distance information with respect to a plurality of said areas of interest, wherein said distance information at one part of said areas of interest acquired on the basis of a distance up to said subject corresponding to a focusing position upon image taking, and distance information that is indicative of a distance longer or shorter than the preset distance up to said subject, which corresponds to said focusing position, is acquired as said distance information at another part of said areas of interest.

17. The image-taking apparatus according to claim 8, wherein said coefficient calculation means uses said position distance corresponding to a site where the distance information is acquired and said distance information to figure out said coefficient.

18. The image-taking apparatus according to claim 17, further comprising a correction means adapted to use said coefficient to correct each pixel after said gray level transformation, wherein said gray level transformation characteristics setting means determines gray level transformation characteristics at said areas of interest, and uses gray level transformation characteristics at said areas of interest to determine gray level transformation characteristics at a pixel position other than said areas of interest.

19. The image-taking apparatus according to claim 18, wherein said gray level transformation characteristics setting means comprises a histogram calculation means for figuring out a histogram of an area near a pixel of interest in said areas of interest, and wherein said gray level transformation characteristics are determined on the basis of said histogram.

20. The image-taking apparatus according to claim 18, further comprising a gray level transformation characteristics retention means for retaining plural types of present gray level transformation characteristics, wherein said gray level transformation characteristics setting means selects said gray level transformation characteristics from among said plural types of gray level transformation characteristics.

21. The image-taking apparatus according to claim 18, wherein said gray level transformation characteristics setting means sets a gamma value of a gray level transformation curve represented by said gray level transformation characteristics, thereby determining said gray level transformation characteristics.

22. An image signal processing program, wherein a computer implements a step of reading image signals obtained by taking a subject, a step of acquiring distance information indicative of a distance up to said subject upon image taking, a step of using position information indicative of a position of a pixel to be processed in an image represented by said image signals and said distance information to determine gray level transformation characteristics, and a step of applying gray level transformation to said image signals depending on said gray level transformation characteristics.

23. An image signal processing program, wherein a computer implements a step of reading image signals obtained by taking a subject, a step of acquiring distance information up to the subject, a step of setting an area of interest in said image signals, a step of using said distance information to figure out a correction coefficient regarding said area of interest, and a step of using said correction coefficient to apply gray level transformation to said image signals.

24. The image-taking apparatus according to claim 2, wherein said gray level transformation characteristics setting means determines gray level transformation characteristics in such a way that the nearer said position of a pixel to be processed in said image is to the center of said image, the smaller a difference between an input value and an output value becomes.

25. The image-taking apparatus according to claim 24, wherein said gray level transformation characteristics setting means determines gray level transformation characteristics in such a way that the shorter a distance thereof with said subject at said position of a pixel to be processed in said image is, the smaller a difference between an input value and an output value becomes.

26. The image-taking apparatus according to claim 2, wherein said gray level transformation characteristics setting means determines gray level transformation characteristics in such a way that the shorter a distance thereof with said subject at said position of a pixel to be processed in said image is, the smaller a difference between an input value and an output value becomes.

27. The image-taking apparatus according to claim 3, wherein said gray level transformation characteristics setting means determines gray level transformation characteristics in such a way that the shorter a distance thereof with said subject at said position of a pixel to be processed in said image is, the smaller a difference between an input value and an output value becomes.
